(19) United States
(12) Patent Application Publication
(10) Pub. No.: US 2007/0278707 A1
(43) Pub. Date: Dec. 6, 2007

(54) Tire mold having air vents and vent plugs, and method for the manufacture thereof

(76) Inventor: Bernard M. Koberlein, North Canton, OH (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/809,949

(22) Filed: Jun. 4, 2007

Related U.S. Application Data
(60) Provisional application No. 60/810,794, filed on Jun. 2, 2006.

(51) Int. Cl. B29C 33/40

(52) U.S. Cl. 264/28; 264/219; 425/35; 425/812

(57) ABSTRACT

A tire mold for molding a rubber or plastic article includes an aluminum tire mold having an internal mold cavity, at least one vent hole of a selected diameter extending from the mold cavity to the exterior of the mold. A metal vent plug is operatively disposed within the vent hole such that air may be released through the vent hole from the internal mold cavity to the exterior of the mold upon heating the entire mold during molding of the rubber or plastic article, but prevents any rubber or plastic from entering the vent hole during molding of the rubber article. This is done by heating the aluminum tire mold, then inserting a metal vent plug into each vent hole; then cooling the entire aluminum tire mold with the metal vent plug to room temperature; then freezing the aluminum tire mold to a temperature of at least about −100° F. for at least one-half hour such that the aluminum tire mold deforms around each metal vent plug; and finally, removing the mold from the freezing conditions.

### CROSS-REFERENCE TO RELATED APPLICATIONS

This application claims the benefit of U.S. Provisional Application No. 60/810,794, filed Jun. 2, 2006, the entirety of that application being incorporated herein by reference.

### TECHNICAL FIELD

This invention relates generally to tire molds and, more particularly, to tire molds of the type having air vents for the release of air from the mold during manufacture of rubber tires or similar products. The invention also relates to a method for the manufacture of the tire mold.

### BACKGROUND FOR THE INVENTION

Tire molds are used in the tire industry for the production of tires. There are a variety of types of tire molds and, while the present invention should not necessarily be limited thereto, the present invention is most particularly directed to the production and manufacture of a flat retread tire mold, wherein the mold is an essentially fiat mold tray for the production of tread that will later be manufactured onto a tire as would be well known in the industry. In these molds, heretofore made of aluminum or non-ferrous metal, rubber would be poured, usually under heat and pressure, into the molds and pressed into a form of a tread pattern suitable for the tire on which the tread would be then adhered.

Such fiat retread tire molds are generally known in the art. However, heretofore, there have been several problems associated with these molds that had yet to be resolved. For example, venting of air during the rubber molding process has previously been performed by providing smallish holes in the base of the mold at the outer periphery of the tire tread pattern. Consequently, when rubber was pressed into the molds, air in the mold would escape through the smallish holes.

However, in addition to air, the smallish holes necessarily allowed rubber to be pressed into them. This caused two problems. First, upon cooling and release of the rubber tread from the tire mold, there would remain a smallish rubber spike on the tire tread that would then have to be removed by tire manufacturing personnel or would remain on the tire retread, providing a very unaesthetic appearance. Second, the rubber, once pressed into the holes, would sometimes break from the tire retread during removal of the tire retread from the mold. Thus, before the tire mold could be used again, the rubber would have to be removed from the air vent in the tire mold, a tedious and time-consuming process, costing the tire manufacture thousands of dollars in lost productivity and/or personnel costs.

Accordingly, attempts have been made to develop tire molds that would not leave these rubber spikes on the molded tire retreads. To that end, air vent plugs were developed to prevent rubber from forming in the air vent holes. These plugs essentially plugged the air vent holes. But there were still problems. First, in some instances the plugs were made of aluminum and would expand too rapidly to permit the air to be released from the tire mold during the rubber tread molding process. In other instances, the plugs were not sufficient large enough to prevent the rubber from “seeping” into the gaps left between the plug and the base of the tire mold. Yet other problems were caused by plugs having smaller holes in them to allow the air to escape. In this instance, the rubber still “seeped” into those smaller holes. Still further, and perhaps most problematic to the tire industry, is that none of the air vent plugs heretofore designed would even work sufficiently when high efficiency rubber, a harder, more cost effective rubber, was used as the rubber in the mold.

Thus, a need exists in the industry for the production of a tire mold that will properly vent air from the mold and allow its escape during the tire tread molding process, but that will not allow the rubber to “seep” into any gaps between the air vent plug and the base of the tire mold. Moreover, a need exists for a tire mold having air vents that can be used in the production of tires having high efficiency rubber.

### SUMMARY OF THE INVENTION

One or more aspects of the present invention may be achieved by an aluminum tire mold for the molding of a rubber or plastic article comprising an internal mold cavity and at least one vent hole of a selected diameter extending from the mold cavity to the exterior of the mold; a metal vent plug operatively disposed within the vent hole such that air may be released through the vent hole from the internal mold cavity to the exterior of the mold upon heating the entire mold during molding of the rubber article, but no rubber may be disposed within the vent hole during molding of the rubber article.

One or more other aspects of the present invention may be achieved by a method for the manufacture of a tire mold comprising the steps of providing an aluminum tire mold having a desired tire tread pattern for molding a tire and at least one vent hole of a selected diameter; heating the aluminum tire mold and inserting a metal vent plug into each vent hole; cooling the entire aluminum tire mold to room temperature; freezing the aluminum tire mold to a temperature of at least about −100° F. for at least one-half hour such that the aluminum tire mold deforms around each metal vent plug; and removing the aluminum tire mold from the freezing conditions to room temperature.

Upon the manufacture of the tire mold as described above, each metal vent plug will operatively permit the release of air from the interior cavity of the mold to its exterior through its respective vent hole upon heating of the mold during operation in the molding and forming of a rubber or plastic article. However, because the amount of expansion of the aluminum of the tire mold is not excessively greater than the amount of expansion of the metal of the vent plug, only a minute or nanometer-sized gap is ever created between the metal vent plug and the mold vent hole wall. Therefore, no rubber or plastic used in the production of the rubber or plastic article during the molding process can get into the vent holes.

These and other aspects of the present invention, which will become apparent from the description and drawings to follow, are accomplished by the improvements hereinafter described and claimed. An exemplary embodiment of a tire mold incorporating the concepts of the present invention is shown by way of example in the accompanying drawings without attempting to show all of the various forms and modifications in which the invention might be embodied, the invention being measured by any appended claims and not by the details of the specification.

### BRIEF DESCRIPTION OF THE DRAWINGS

FIG. 1 is a perspective view of a portion of a flat tire retread mold according to the present invention.

FIG. 2 is a cross-sectional view of a portion of the flat tire retread mold taken along line 2-2 in FIG. 1, showing an air vent plug incorporated into a vent hole of the flat tire retread mold.

FIG. 3 is a cross-sectional view of the same portion of the flat tire retread mold taken along line 2-2 in FIG. 1, showing the air vent plug releasing air from the mold.

### DETAILED DESCRIPTION FOR CARRYING OUT THE INVENTION

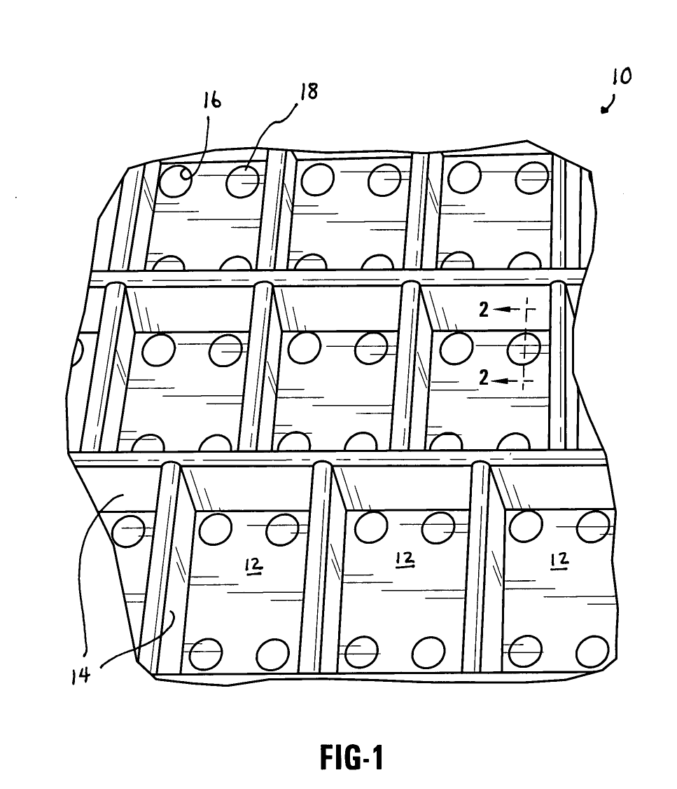

A portion of a tire mold according to the present invention is shown generally in FIG. 1 and is indicated generally by the numeral 10. The tire mold 10 may be any tire mold known in the art but, for purposes of this embodiment, is illustrated as a flat retread tire mold of the type known in the tire molding art for producing rubber tread stocks for the retreading of tires. In one embodiment, the tire mold is made of aluminum. The internal cavity side of the mold 10 for receiving rubber, plastic, or other moldable material is shown schematically in FIG. 1 and, includes generally smooth base surfaces 12 and various protruding walls 14. It will be appreciated that base surfaces 12 aid in the formation of the outer periphery of the tire tread, while the protruding walls 14 aid in the formation of the grooves of the tire tread upon molding of the article to be molded. That is, the internal cavity surface of the mold 10 is the complementary opposite surface of the desired tread pattern for the tire or other article to be molded. Thus, it will be understood that the configuration of the tire mold shown in for illustrative purposes only and that the base surfaces 12 and protruding walls 14 may take any desired form or design known in the art suitable for molding purposes.

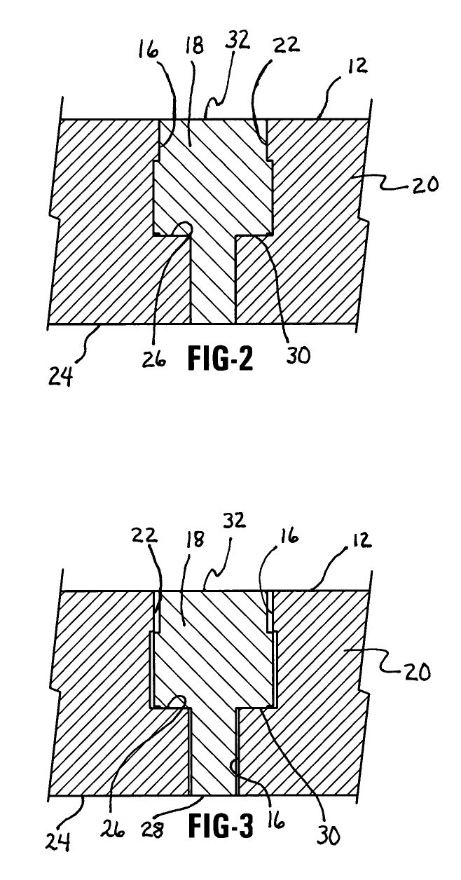

Disposed within the tire mold 10 are one or more air vent holes 16 that have been plugged by inserts such as vent plugs 18. In one embodiment, the vent holes 16 are disposed in the base surface 12 of the tire mold. In another embodiment, there may be from one to four or more vent holes 16 in each base surface section 12. In the embodiment shown in FIG. 1, there are four separate vent holes 16 in each base surface section 12 of the tire mold 10 shown. In the embodiment shown, the vent holes are generally cylindrical holes of varying diameter along each hole's axial length and, as can be more particularly seen in FIGS. 2 and 3, are disposed completely through the base 20 of the tire mold 10, thereby providing a passageway from the internal mold cavity to the exterior of the mold.

As noted, vent holes 16 are each plugged with vent plugs 18. In at least one embodiment, the vent plugs 18 may be made of metal. In another embodiment, vent plugs 18 are essentially complementary in shape to the vent holes 16 in which they are inserted. A more detailed description of how they are made to be essentially complementary to the air vent holes will be discussed hereinafter. In a least one embodiment, the vent plugs 18 are generally cylindrical inserts of varying diameter along each plug's axial length. In another embodiment, the vent plugs 18 are cylindrical inserts of one diameter and are inserted into the vent holes 16 from within the internal cavity side of the mold 10, ending where the diameter of the vent hole narrows toward the exterior of the mold 10. In such an embodiment, the vent plugs 18 may include a grooved slot (not shown) within the surface of the vent plug facing the exterior of the mold such that air can be released through the slot from the gap created between the vent plug 18 and vent hole 16 as detailed below.

With particular reference to the embodiment of the air vent holes 16 and vent plugs 18 set forth and shown in FIGS. 2 and 3, it can be seen that air vent holes 16 are defined by aperture wall 22 in base 20 of tire mold 10. Aperture wall 22 is cylindrical and of relative narrow diameter at its end near the exterior surface 24 of the tire mold 10. It then widens to a significant diameter near the middle of base 20 so as to provide a shelf surface 26 for vent plug 18. In one embodiment and as shown, aperture wall 22 then narrows very slightly in diameter proximate the interior base surface 12 forming the internal cavity of the tire mold 10. It will be appreciated that this narrowing of in diameter of the cylindrical wall 22 is not originally formed when the tire mold 10 is initially produced. It is only after the vent plug 18 has been inserted and the manufacturing process for the tire mold 10 completed, that this narrowing in the diameter of the cylindrical walls 22 can be noticed. In one embodiment, the vent holes may be from about ⅛ inch to about ½ inch in diameter.

The vent plug 18 is essentially complementary in shape to the aperture wall 22 as seen in FIGS. 2 and 3. The vent plug 18 may be cylindrical and be of relatively narrow diameter near its end that is to be inserted through the vent hole 16. In one embodiment, the inserted end 28 of vent plug 18 ends at the exterior surface 24 of the mold 10. The middle portion of vent plug 18 is of significantly greater diameter than its inserted end portion and provides a radial surface 30 that may or may not contact or otherwise engage the shelf surface 26 of the cylindrical wall 22. In one embodiment, the vent plugs may be from about ⅛ inch to about ½ inch in diameter. Finally, the inner portion of the vent plug 18 may be of slightly less diameter than is the middle portion of the vent plug 18. In at least one embodiment, the interior end surface 32 of the vent plug 18 should be smooth and complementary with the internal base surface 12 of the tire mold. This will enable molding of an article without a noticeable groove or protrusion in the molded article.

In another embodiment, the vent plug 18 may be completely cylindrical with one diameter. It will be appreciated that, in this particular embodiment, the deformity in wall 22 will not be present as the vent plug 18 will remain the same diameter. Furthermore, the outer surface of the vent plug may terminate before the narrow diameter of the vent hole 16 exiting to the exterior of the mold 10. In this case, a narrowly grooved slot could be present on the outer surface of the vent plug extending across the entire diameter of the vent plug 18 to provide a way for the air trapped in the gap between the vent hole and vent plug to be released to the exterior of the mold 10.

To produce the tire mold of the present invention, the manufacturer must first produce a tire mold. The production of such tire molds are well known in the art and essentially any tire mold suitable for producing molded articles may be used. In at least one embodiment, the tire mold may be made of aluminum. In the same or another embodiment, the tire mold may be a flat retread tire mold and have a desired tire tread pattern for molding a tire. The tire mold should include at least one air vent hole of a selected diameter.

Before any vent plugs are inserted into the air vent holes in the tire mold, the tire mold is heated. In one embodiment, the tire mold may be heated to at least about 100° F., while in another embodiment, the tire mold may be heated to at least about 400° F. In yet another embodiment, the tire mold is heated to between about 375° F. and about 400° F. By heating the tire mold, the aluminum will expand and permit the manufacture to insert a vent plug into each vent hole in the tire mold. In one embodiment, the vent plug is made of metal. In the same or another embodiment, the vent plug is complementary to the vent hole and is inserted into the vent hole so as to provide a very tight fit. In fact, it is not unusual for the manufacturer to peen the mold around the plug in order to provide a smooth surface between the base tire mold and the end surface of the vent plug. The smoother the surface junction between the vent plug and the base surface of the tire mold on the internal cavity side of the mold, the more aesthetic the appearance of the molded article once molded.

After the vent plug has been properly and operatively disposed within the vent hole of the tire mold, the tire mold may be cooled. In one embodiment, the entire aluminum tire mold is cooled to room temperature, about 70° F. Once the mold has been cooled to room temperature, the mold is then frozen. In one embodiment, the mold may be frozen to a temperature of at least about −100° F. for at least one-half hour. In another embodiment, the mold may be frozen to a temperature of at least about −400° F. for at least one-half hour. In yet another embodiment, the mold is submerged in liquid nitrogen for at least 1 minute, and in yet another embodiment, the mold is submerged in liquid nitrogen for at least one-half hour. Notably, freezing of the aluminum mold with the metal vent plugs inserted in the air vent holes causes the aluminum tire mold to deform about each metal vent plug. That is, because the amount of contraction of the aluminum of the tire mold is greater than the amount of contraction of the metal of the vent plug, the aperture walls of each air vent hole of the aluminum mold deforms around and takes the shape of the metal vent plug. Thus, where the original aperture wall of the air vent hole was substantially of the same diameter from the internal cavity of the mold to the shelf surface of the wall, the aperture walls of the air vent holes of the mold are now “coined” or deformed into the shape of the vent plug itself. Thus, upon “coining” or deforming the aperture walls 22 of the vent holes 16, the inserted vent plug 18 and base 20 of the mold 10 will now look as shown in FIG. 2. Essentially, each vent plug 18 is tightly sealed within each vent hole 16 of the mold.

Once the mold has been thoroughly frozen, the tire mold may be removed from the freezing conditions and/or temperature and returned to room temperature, about 70° F. The mold is now ready to be used in the manufacture of a molded rubber or plastic article.

To mold a rubber or plastic article using the tire mold of the present invention, the rubber or plastic is poured into the mold under appropriate heat and pressure conditions. Typically, such conditions include heating the rubber and the mold to at least about 100° F. and more typically, to at least about 350° F. or even 375° F. It will be appreciated that upon being heated, the aluminum mold will expansion at a slightly greater rate than will the metal vent plug and, consequently, a very minute or nanometer-sized gap may be created between the vent plug and the mold wall. This nano-sized gap operatively permits the release of air around the vent plugs from the interior cavity of the mold to its exterior through the vent holes. Hence, the heating of the mold during the rubber or plastic molding process permits each metal vent plug to operatively release air from the interior cavity of the mold to its exterior through its respective vent hole. However, because the amount of expansion of the aluminum of the tire mold is not excessively greater than the amount of expansion of the metal of the vent plug, only a minute or nanometer-sized gap is ever created between the metal vent plug and the mold aperture wall. Therefore, no rubber or plastic used in the production of the rubber or plastic molded article during the molding process can get into the vent holes. The gap for the venting of air is only big enough for air to pass through, not any rubber or plastic.

Thus, it should be evident that the method and mold disclosed herein is capable of removing air from the internal cavity of a mold during the molding process without enabling the rubber or plastic used in the molded article to “seep” or otherwise enter the air vent holes of the tire mold. Moreover, it has been found that the mold of the present invention is particularly suitable for use with high efficiency rubber as the molding compound. High efficiency rubber is considerably harder than most other rubbers but is preferred by the tire manufacturers because it can be used to produce tire more efficiently. It will be further evident that the method of the present invention can be used with different materials and with different venting applications beyond rubber and plastic tire molding.

One skilled in the art will appreciate that the method and mold as exemplified herein may be varied without departing from the scope of the invention. Moreover, the invention includes all such modifications and variations that fall within the scope of the attached claims.

What is claimed is:

1. A tire mold for the molding of a rubber or plastic article, the tire mold being made of aluminum and comprising: an exterior; an internal mold cavity; at least one vent hole of a selected diameter extending from the mold cavity to the exterior of the mold; a metal vent plug operatively disposed within the vent hole such that air may be released through the vent hole from the internal mold cavity to the exterior of the mold upon heating the entire mold during molding of the rubber or plastic article, but preventing any rubber or plastic from entering the vent hole during molding of the rubber article.

2. The tire mold of claim 1, wherein the mold is a flat retread tire mold.

3. The tire mold of claim 1, wherein the internal mold cavity includes a plurality of sections, each section including a base surface and one or more protruding walls, and wherein the vent holes are disposed on each base surface.

4. The tire mold of claim 3, wherein four vent holes are disposed on each base surface.

5. The tire mold of claim 1, wherein the vent holes are cylindrical.

6. The tire mold of claim 1, wherein the vent plug is complementary in shape to the vent hole in which the vent plug is disposed.

7. A method for the manufacture of a tire mold comprising:
providing an aluminum tire mold having a desired tire tread pattern for molding a tire and at least one vent hole of a selected diameter;
heating the aluminum tire mold;
inserting a metal vent plug into each vent hole;
cooling the entire aluminum tire mold with the metal vent plug to room temperature;
freezing the aluminum tire mold to a temperature of at least about −100° F. for at least one-half hour such that the aluminum tire mold deforms around each metal vent plug; and
removing the aluminum tire mold from the freezing conditions to room temperature.

8. The method of claim 7, wherein the step of heating includes heating the mold to at least 100° F.

9. The method of claim 7, wherein the step of heating includes heating the mold to at least 400° F.

10. The method of claim 7, wherein the step of cooling includes cooling the mold to room temperature.

11. The method of claim 7, wherein the step of freezing includes freezing the mold to a temperature of at least about −400° F. for at least one-half hour.

12. The method of claim 11, wherein the vent hole is deformed into the shape of the vent plug.

13. A method for the manufacture of a molded article comprising:
providing a mold having a particular rate of expansion and contraction upon heating and cooling, respectively, the mold having at least one vent hole of a selected diameter;
heating the mold;
inserting a vent plug having a particular rate of expansion and contraction upon heating and cooling, respectively, that is less than the rate of expansion of the mold into each vent hole;
cooling the entire mold with the vent plug to room temperature;
freezing the mold to a temperature sufficient to contract the mold such that the mold deforms around each vent plug; and
removing the mold from the freezing conditions to room temperature.

14. The method of claim 13, wherein the step of heating includes heating the mold to at least 100° F.

15. The method of claim 13, wherein the step of heating includes heating the mold to at least 400° F.

16. The method of claim 13, wherein the step of cooling includes cooling the mold to at least −100° F.

17. The method of claim 13, wherein the step of cooling includes cooling the mold to at least −400° F.
